(19) United States
(12) Patent Application Publication
(10) Pub. No.: US 2009/0267513 A1
(43) Pub. Date: Oct. 29, 2009

(54) High-Pressure Discharge Lamp With Ceramic Discharge Vessel

(75) Inventor: Dieter Trypke, Falkensee (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRANKTER HAFTUNG, München (DE)

(21) Appl. No.: 12/086,075

(22) PCT Filed: Nov. 29, 2006
(86) PCT No.: PCT/EP2006/069043

§ 371 Date: Jun. 5, 2008

(30) Foreign Application Priority Data
Dec. 9, 2005 (DE) 10 2005 058 896.4

(51) Int. Cl. H01J 61/36

(52) U.S. Cl. 313/625

(57) ABSTRACT

At least on one end (6a) of a metal halogenide lamp comprising a ceramic discharge vessel, the stopper (11) homogeneously consists of an MoV alloy. The stopper is welded to the duct (9) on the outside.

### TECHNICAL FIELD

The invention is based on a high-pressure discharge lamp with ceramic discharge vessel in accordance with the preamble of claim 1. What is involved here is, in particular, metal halide lamps, especially for general lighting, or else high-pressure sodium lamps.

### PRIOR ART

EP-A 887 840 discloses a generic lamp in the case of which the sealing of the lead-through in the ceramic discharge vessel is performed as direct sintering in by means of a stopper made from weldable material. Use is made in this case of a multipartite stopper that consists of individual layers of a cermet in which various fractions of metal ceramic are present. Such a stopper must, however, be separately produced in advance and is expensive. Moreover, it is relatively long, given that at least four layers are required.

### SUMMARY OF THE INVENTION

It is an object of the present invention to provide a metal halide lamp with ceramic discharge vessel in accordance with the preamble of claim 1 which has a long service life and dispenses with soldering glass. In particular, the sealing region is intended to be vacuum-tight, resistant to high temperatures and not susceptible to corrosion.

This object is achieved by the characterizing features of claim 1. Particularly advantageous configurations are to be found in the dependent claims.

According to the invention, the stopper at at least one end of the discharge vessel consists in one part of a molybdenum/vanadium alloy (MoV), the vanadium content being below 50% by weight. It is essential for the invention in this case that the stopper easily facilitate weldability to the lead-through. This purpose requires an electrical conductivity of at least 5 mΩ for this layer. The advantage of this unipartite stopper is that it can be kept very short, the lamp thus being capable of better miniaturization.

A fraction of vanadium is preferably in the range of 20 to 40% by weight, since the relative expansion differences can be kept sufficiently small.

The ceramic discharge vessel has tubular end regions in which the stopper is fitted. The stopper is seated in the end region by being sintered in directly.

The lead-through is joined to this stopper in a vacuum-tight manner by welding, in particular by laser welding. The advantage of a sealing of the discharge vessel by welding resides in the high corrosion resistance, high thermal loading capacity and great strength of such a weld.

A pin or tube that is electrically conductive can be used as lead-through. At least in what concerns the thermal expansion coefficient, the material of the lead-through should be matched as well as possible to the stopper, in particular to its composition. In the ideal case, it agrees with it, but deviations are possible.

The stopper is joined to the end of the discharge vessel without the use of soldering glass. This is generally done by sintering in directly. The lead-through is likewise also joined to the stopper by being sintered in directly.

A decisive advantage of the present invention is that no thermal expansion differences worth mentioning occur in a suitable selection of the relative fraction of vanadium in the stopper. The sealing is particularly durable, because welding results in a firm and durable joint that is superior in this regard to the technique of sintering in or sealing in. Moreover, in the case of a lead-through made from pure metals such as molybdenum and tungsten, and in the case of cermet greatly enriched with metal, small expansion differences do not lead so quickly to cracks, since stresses are more easily relieved by the elasticity of the metal.

The lead-through can be a pin made from high temperature metal, in particular tungsten, molybdenum, or from a cermet that consists of a mixture of aluminum oxide and tungsten or molybdenum.

In a second embodiment, the lead-through is a tube made from high temperature metal. This form is particularly advantageous in the case of high-wattage lamps (typically 250 to 400 W). The use of a tube as lead-through has the advantage that even relatively large bores in the stopper that are required for lead-throughs of large electrodes for high-wattage lamps can be sealed without excessively large heat losses for the electrode. When use is made of an electrode system comprising tubular lead-through and electrode, and this is provisionally also sintered in when the stopper is sintered in at the end of the discharge vessel, this opening can be selected independently of electrode size. In this case, the opening is subsequently closed off by a fill pin, it being possible for fill pin, tube and cermet to be welded in one step. It is therefore possible to dispense entirely with a separate fill bore in the stopper, as previously often required.

In detail, the present invention concerns a high-pressure discharge lamp with ceramic discharge vessel (made from aluminum oxide) that is usually surrounded by an outer bulb. The discharge vessel has two ends that are closed off by sealing means. This is usually a unipartite or multipartite stopper. The structure described is implemented at least at one end of the discharge vessel. Led through a central bore of the stopper in a vacuum-tight manner is an electrically conductive lead-through to which there is secured an electrode which has a shaft and projects into the interior of the discharge vessel. The lead-through is a component made from metal or a cermet whose metal fraction is so high that it can be welded like a metal, the lead-through being secured in the stopper by means of a welded joint, that is to say without the use of soldering glass. Moreover, the stopper itself is also secured in the discharge vessel without the use of soldering glass. This is usually done by sintering in directly.

In a preferred embodiment, the lead-through is a pin made from electrically conductive cermet, the shaft of the electrode being butt welded to the end face of the pin. The pin itself is welded to the stopper. The advantage of this arrangement is that the thermal expansion difference between pin and stopper is relatively slight. Moreover, cermet is not such a good thermal conductor as metal.

It is advantageous for the lead-through to be recessed into the stopper, so that contact with the fill is minimized and the thermal load is reduced.

In a second particularly preferred embodiment, which is suitable in particular for low-wattage lamps, the lead-through is an electrically conductive pin made from metal. The pin can itself serve as electrode shaft or be joined thereto. It can also project outward beyond the stopper in order to facilitate connection to the outer supply lead. This lead-through pin preferably consists of tungsten or molybdenum. It can be coated with rhenium.

Finally, the invention leads to ceramic metal halide lamps free from capillaries. The function of the capillaries consists in leading the point of the sealing, usually by means of soldering glass, into an uncritical temperature range. Here, uncritical temperature range means that the different coefficients of linear expansion of the materials in the sealing zone do not lead to a formation of cracks in the ceramic. Moreover, the temperature of the soldering glass in the sealing zone need not be kept so low that no reactions with the fill will occur or the soldering glass become viscous again.

An electrode system is guided into the discharge vessel through the capillary. Parts of the electrode system, previously these have been Mo and Nb components, serve the purpose of current conduction. The inside diameter of the capillary and the outside diameter of the electrode system must be selected such that no overlapping of the diameters is possible, that is to say the subassemblies are suitable for machines. Consequently, a free space, the so-called dead volume, is always formed in the capillary. Since, because of the decreasing temperature above it, the capillary acts as a cooling trap, a portion of the fill is deposited in this dead volume (irreversibly in part). This leads to color temperature scattering at any time during the burning life. Switch off measures such as, for example, a raising of fill quantity, are possible only to a limited extent without, in turn, triggering other early failure mechanisms.

A further disadvantage of the previous closing off technique by means of soldering glass is the duration of the sealing process, which takes a few seconds. The sealing length is also subject to scattering caused by the method, this being associated with cost intensive outlay on machinery. In particular, sealing lengths at the upper edge of the permissible length scattering are critical for various applications. Investigations show that relatively long seals tend to lead to formation of cracks. Closing-off in accordance with the present invention, something which is preferably executed by means of laser welding, lasts only a few milliseconds. Heating up the entire discharge vessel, such as has happened so far, is avoided by the short laser pulse time.

Furthermore, the lamp length can be reduced by the invention, that is to say compact lamps are preferably implemented. The invention saves expensive materials, such as Nb(Zr), for example, for the manufacture of electrode systems and lamps, and reduces the manufacturing depth in the manufacture of electrode systems and burners. An effect of synergy with regard to the construction and closing-off time occurs as regards discharge vessels for high-pressure sodium lamps.

### FIGURES

The invention is to be explained in more detail below with reference to a number of exemplary embodiments. In the drawings:

FIG. 1 shows a metal halide lamp with ceramic discharge vessel, partially in section;

FIGS. 2 to 4 show a detail of the end region of the ceramic discharge vessel in various exemplary embodiments; and

FIG. 5 shows a high-pressure sodium lamp with ceramic discharge vessel, partially in section.

### DESCRIPTION OF A PREFERRED EMBODIMENT

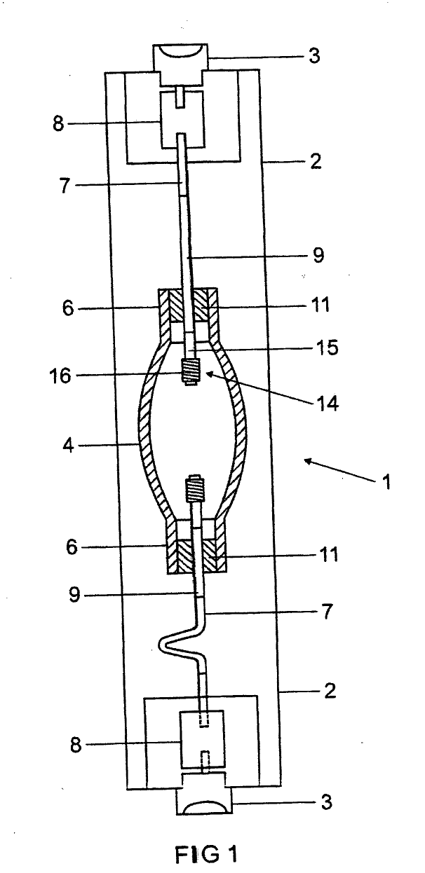

FIG. 1 schematically illustrates a metal halide lamp with an output of 150 W. It comprises a cylindrical outer bulb 1 which defines a lamp axis, is made from quartz glass and is pinched (2) and capped (3) on two sides. The axially arranged discharge vessel 4 made from Al₂O₃ ceramic bulges in the centre and has two cylindrical ends 6. It is held in the outer bulb 1 by means of two supply leads 7 which are connected to the cap parts 3 via foils 8. The supply conductors 7 are welded to lead-throughs 9, which are each fitted into a stopper 11 at the end 6 of the discharge vessel.

The lead-throughs 9 are pins made from cermet or molybdenum with a diameter of approximately 1 mm. The cermet is conductive and weldable and consists of approximately 50% by volume of tungsten (or else molybdenum), the remainder being aluminum oxide.

Both lead-throughs 9 project outside at the stopper 11 and on the discharge side hold electrodes 14 comprising an electrode shaft 15 made from tungsten and a filament 16 which has been pushed onto the discharge-side end. The lead-through 9 is in each case butt-welded to the electrode shaft 15 and to the outer supply lead 7.

The fill of the discharge vessel consists, in addition to an inert firing gas, of, for example, argon, mercury and additions of metal halides. By way of example, it is also possible to use a metal halide fill without mercury, in which case a high pressure is selected for the firing gas xenon.

The end stops 11 consist of an MoV alloy, the fraction of the vanadium being between 10 and 50% by weight. The fraction of the vanadium is preferably 20 to 40% by weight. They are thereby particularly suitable for welding to the lead-throughs, in particular with pure Mo pins.

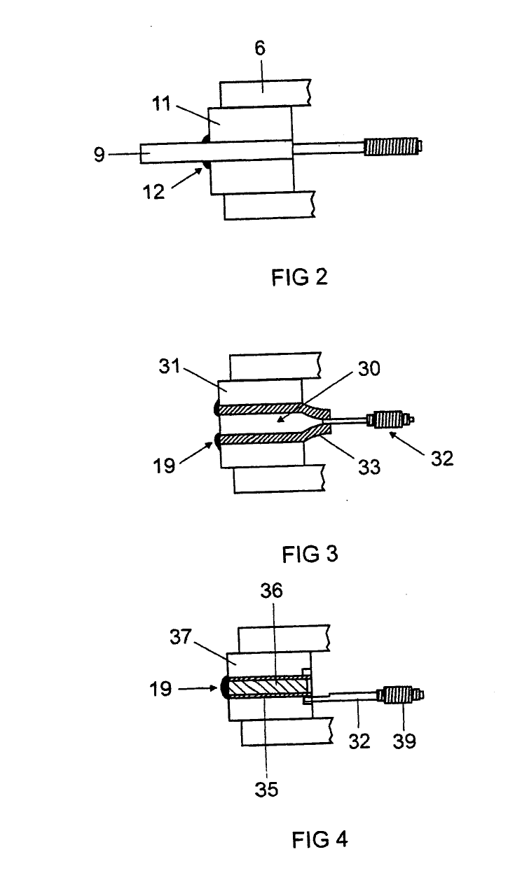

FIG. 2 shows an end region of the discharge vessel in detail. The stopper 11 consists uniformly of MoV, and is partially inserted in the cylindrical end 6 of the discharge vessel. The stopper is sintered directly into the end 6, that is to say without soldering glass. In the case of direct sintering in, the discharge vessel is firstly still in the green state when the stopper is inserted into the end, and shrinks onto the stopper during the final sintering. Typical temperatures of the sintering lie at 1500 to 2000° C. This technique is known per se, see EP-A 887 839. The shrinkage is of the order of magnitude of a few up to 20 percent.

Here, the stopper can be a cermet made from Mo, V and Al₂O₃ that is electrically conductive and weldable. However, the stopper can also consist of an MoV alloy that is weldable, in any case. In each case, the stopper 11 is joined at its outer surface to the lead-through 9 by laser welding. The welding spots are noted by 12. In the actual case of FIG. 2, the stopper 11 consists of approximately 25% by weight of vanadium, the remainder being molybdenum.

In a further exemplary embodiment of FIG. 3, the lead-through at the ends 6 of the discharge vessel is implemented by a molybdenum tube 30 that is welded (19) in a stopper made from MoV 31, at the outer end. The molybdenum tube 30 holds the electrode 32 by means of crimping 33.

In a further exemplary embodiment of a high-wattage lamp with a power of 250 W (FIG. 4), the lead-through tube 35 made from molybdenum can also have an entirely cylindrical shape. Secured outside eccentrically to its end on the discharge side is the electrode 32 with a wide head 39 (two-layer filament). For the purpose of fixing provisionally in the stopper 37 made from MoV, the stopper 37 is firstly joined to the molybdenum tube 35 by sintering.

After the evacuation and filling, the tube 35 is closed off by a metal pin 36 that is welded to the tube 35. The tube 35 is simultaneously welded in this case to the stopper 37. That is to say, the final, permanent sealing of the bore of the stopper is performed by welding 19, since this technique is superior to directly sintering in.

The tube technique is also very well suited for large wattages in the case of which the electrode has a large diameter and large transverse dimensions. The tube diameter is therefore relatively uncritical, because the difference in thermal expansion behavior between lead-through and outermost layer at the end of the stopper can be kept very small. In this case, a similar material, in particular the same material, is selected for tube and outermost layer of the stopper.

Weld-sealing the annular gap between tube and stopper or tube and filling pin is possible without any problem even when these parts have large diameters.

In the case of large wattages, tubes are preferred as lead-through, because pins, which are adapted to the required large diameters of the electrode extract too much heat. This would lead to substantial startup difficulties when starting the lamp. Consequently, the tube technique presented here is capable for the first time of reliably sealing metal halide lamps with ceramic discharge vessel even in the case of large wattages (more than 150 W). It is known that the size of the electrode (in particular its outside diameter) rises with the power, but according to the invention there is now no longer any need to enlarge the diameter of the lead-through correspondingly.

In a particularly preferred embodiment, the lead-through is made from pure molybdenum (pin or tube). The above values are selected such that the difference in the thermal expansion coefficient is slight, and they are approximately at the same distance from one another. The load is therefore uniformly distributed. A temperature of 1000° C. is taken as standard in this case.

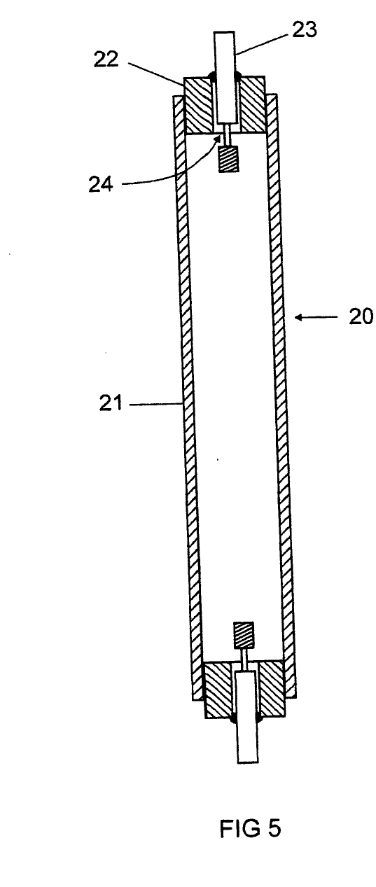

A high-pressure sodium lamp 20 is shown in FIG. 5. Here, the discharge vessel 21 is fabricated from Al₂O₃ and has the shape of a tube of constant diameter in whose end a stopper 22 made from MoV is respectively sintered in. In this case, the same composition of materials can be used as for metal halide lamps, something which affects the discharge vessel and the stopper. The fill contains sodium and mercury as well as noble gas, as is known per se.

The outside diameter of the lead-through 23, for example made from niobium, is adapted as well as possible to the diameter of the bore 24 in the stopper, and corresponds to it, in particular, with an accuracy of 95%.

The lead-through can advantageously also be a pin made from tungsten or molybdenum, in particular it can also be coated with rhenium. This results in a particularly reliable welding to the stopper made from MoV.

In the case when the stopper is sintered in directly at the end of the discharge vessel, a soldering glass that is applied in a known way externally to the contact zone between stopper and discharge vessel can additionally improve the seal.

1. A high-pressure discharge lamp with ceramic discharge vessel (4) made from aluminum oxide, the discharge vessel having two ends (6) that are closed off by stoppers (11), and there being led through these stoppers in a vacuum-tight manner an electrically conductive lead-through (9, 10; 20; 30; 35) to which there is secured an electrode (14) which has a shaft (15) and projects into the interior of the discharge vessel, the stopper consisting of a weldable material, the stopper being welded to the lead-through, characterized in that the stopper is unipartite and consists of an alloy of the metals molybdenum and vanadium, the fraction of the vanadium being at most 50% by weight.

2. The high-pressure discharge lamp as claimed in claim 1, characterized in that the fraction of the vanadium is between 20 and 40% by weight.

3. The high-pressure discharge lamp as claimed in claim 1, characterized in that the lead-through is a pin made from molybdenum or tungsten or rhenium, or is composed of mixtures of them.

4. The high-pressure discharge lamp as claimed in claim 1, characterized in that the lead-through (9) is joined to the outermost layer of the stopper by a weld (19), and the innermost layer (11a) of the stopper being secured in the end of the discharge vessel without the use of soldering glass.

5. The high-pressure discharge lamp as claimed in claim 1, characterized in that the stopper is sintered directly into the end region of the discharge vessel.

6. The high-pressure discharge lamp as claimed in claim 1, characterized in that the discharge vessel consists of aluminum oxide.

7. The high-pressure discharge lamp as claimed in claim 1, characterized in that the lead-through is a tube (30; 35) made of high temperature metal, in particular tungsten or molybdenum.
